(19) United States
(12) Patent Application Publication
(10) Pub. No.: US 2008/0046921 A1
(43) Pub. Date: Feb. 21, 2008

(54) Advertisement Management Device, Advertisement Distribution Device, Advertisement Display Device, Advertisement Distribution Method, And Advertisement Display Method

(76) Inventor: Yusuke Fujimaki, Tokushima-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 11/667,684

(22) PCT Filed: Nov. 14, 2005
(86) PCT No.: PCT/JP05/20898

§ 371 Date: May 14, 2007

(30) Foreign Application Priority Data
Nov. 12, 2004 (JP) 2004-329786

(51) Int. Cl. H04N 7/10

(52) U.S. Cl. 725/34

(57) ABSTRACT

A novel advertisement delivery technique is provided. An advertisement delivery system includes an advertisement providing server, a user terminal, and a sponsor terminal. The sponsor terminal sends an advertisement thereof to the advertisement providing server and asks to deliver the advertisement. The advertisement providing server provides an opportunity in which the user sells an advertisement display scene to an advertiser, namely, in which the user solicits sponsorship of a user's display region. When an agreement is reached between the user and the sponsor, the advertisement providing server delivers the advertisement to the user terminal via the Internet. Upon receiving the timing of the display of the advertisement from an application, the user terminal displays the advertisement corresponded to the scene.

### TECHNICAL FIELD

The present invention relates to an advertisement delivery technique.

### BACKGROUND ART

The widespread use of personal computers and mobile phone terminals is allowing anyone to utilize the Internet. Web services over the Internet are also widely in use. Under the circumstances, there are advertisement delivery techniques of placing a banner advertisement on a web page, when the web page is viewed on a web browser, and opening a new window to display an advertisement. There is another technique of transmitting electronic mail with an advertisement attached thereto.

### DISCLOSURE OF THE INVENTION

### Problems to be Solved by the Invention

Due to rampant spam mail or the like, some users dislike receiving an undesired advertisement in electronic mail. In consideration of the circumstances, the applicant of the present invention has come to invent a more advantageous and novel advertisement delivery technique.

The present invention has been made in view of the above circumstances, and a general purpose of the present invention is to provide an advantageous and novel advertisement delivery technique.

### Means for Solving the Problems

In order to address the above problem, an advertisement management apparatus according to an aspect of the present invention comprising: means for acquiring an advertisement via a network; a table which retains a scene for displaying the advertisement in association with a type of the advertisement to be displayed in the scene; means for acquiring a notification of timing of display of the advertisement from an application; and means for displaying the advertisement associated with the scene at the time of receiving the notification.

Another aspect of the present invention is a an advertisement delivery apparatus connected via a communication network with a terminal apparatus used by a user who has agreed to an advertisement display contract, comprising: an advertisement data retaining unit which retains advertisement data for delivery; an advertisement data transmitter which transmits advertisement data to be displayed to a terminal apparatus so as to display the advertisement data on a screen of the terminal apparatus; a profile information receiver which receives from the terminal apparatus, profile information relating to the terminal apparatus; and an advertisement value determining unit which determines an advertising medium value of the terminal apparatus in accordance with the profile information.

The profile information receiver may receive an actual display result of the advertisement data, as the profile information.

The profile information receiver may receive information indicating a date when the terminal apparatus was purchased by a user, as the profile information.

The profile information receiver may receive information indicating an installed location of the terminal apparatus, as the profile information.

The profile information receiver may receive information relating to a viewer of an advertisement displayed on the terminal apparatus, as the profile information.

The advertisement delivery apparatus may further comprise an actual purchase result information acquiring unit which acquires actual purchase result information for identifying the terminal apparatus that has displayed the advertisement prompting a purchase. The advertisement value determining unit may adjust the advertising medium value of the terminal apparatus in accordance with the actual purchase result.

The advertisement delivery apparatus may further comprise a user information retaining unit which retains user information relating to a user of the terminal apparatus. The advertisement data retaining unit may select the advertisement data to be transmitted to the terminal apparatus in accordance with the user information.

The advertisement value determining unit may calculate the advertising medium value of the terminal apparatus in accordance with an advertised object.

The advertisement data transmitter may select the advertisement data to be sent in accordance with the type of the terminal apparatus.

The advertisement value determining unit may calculate the advertising medium value in accordance with the type of the terminal apparatus.

The advertisement value determining unit may calculate the advertising medium value in accordance with an advertisement display condition set in the terminal apparatus.

Yet another aspect of the present invention is an advertisement display apparatus connected via a communication network with a server apparatus equipped with a function of delivering advertisement data, comprising: an advertisement acquiring unit which receives advertisement data from the server apparatus; an advertisement retaining unit which retains the advertisement data; a screen display unit which displays the advertisement data on a screen; a profile information transmitter which transmits profile information on the advertisement display apparatus to the server apparatus; an advertisement value acquiring unit which receives advertisement value information indicating an advertising medium value of the advertisement display apparatus in accordance with the profile information; and an advertisement value notifying unit which communicates the advertising medium value of the advertisement display apparatus.

The profile information transmitter may transmit information indicating an actual display result of the advertisement data, as the profile information.

The screen display unit which serves as an apparatus dedicated for advertisement display may cause an application dedicated for advertisement display to display the advertisement data on a screen.

The screen display unit may display the advertisement data when a predetermined advertisement display condition is satisfied, and displays image data other than the advertisement data when the advertisement display condition is not satisfied.

The screen display unit may display the advertisement data on a desktop screen of a personal computer.

The screen display unit may display the advertisement data as a screen saver.

Further another aspect of the present invention is an advertisement delivery method performed by an apparatus connected via a communication network with a terminal apparatus used by a user who has concluded an advertisement display contract, the advertisement delivery method comprising: transmitting advertisement data to be displayed to a terminal apparatus so as to display the advertisement data on a screen of the terminal apparatus; receiving from the terminal apparatus, profile information of the terminal apparatus; and calculating an advertising medium value of the terminal apparatus in accordance with the profile information.

Further another aspect of the present invention is an advertisement display method performed by a terminal apparatus connected via a communication network with a server apparatus equipped with a function of delivering advertisement data, comprising: receiving the advertisement data from the server apparatus; displaying the advertisement data on a screen; transmitting profile information of the terminal apparatus to the server apparatus; receiving advertising value information indicating an advertising medium value of the terminal apparatus in accordance with the profile information, from the server apparatus; and communicating the advertising medium value of the terminal apparatus to a user.

Optional combinations of the aforementioned constituting elements and implementations of the present invention in the form of methods, processors, apparatus, systems, computer programs, data structures etc. may also be practiced as additional modes of the present invention.

### ADVANTAGES EFFECT OF THE INVENTION

According to the present invention, an advantageous and novel advertisement delivery technique is provided.

### BRIEF DESCRIPTION OF THE DRAWINGS

FIG. 1 is a diagram showing a configuration of an advertisement delivery system according to an embodiment of the present invention;

FIG. 2 is a diagram showing a configuration of a user terminal according to an embodiment of the present invention;

FIG. 3 is a functional block diagram showing another configuration of the user terminal of FIG. 2;

FIG. 4 is a functional block diagram of an advertisement providing server that delivers advertisement data to the user terminal of FIG. 3;

FIG. 5 illustrates a data structure of apparatus information in terminal information;

FIG. 6 illustrates a data structure of user information in the terminal information; and

FIG. 7 illustrates a data structure of usage information in the terminal information.

### REFERENCE NUMERALS

1 advertisement delivery system, 3 advertisement providing server, 4 user terminal, 5 sponsor terminal, 6 advertisement acquiring unit, 7 advertisement display unit, 8 application, 9 display apparatus, 10 advertisement retaining unit, 11 table, 12 advertisement value acquiring unit, 14 terminal information transmitter, 20 communication unit, 22 data processing unit, 24 data retaining unit, 26 advertisement acquiring unit, 28 advertisement transmitter, 30 terminal information receiver, 32 advertisement value transmitter, 34 delivery controller, 36 advertisement value calculator, 38 advertisement retaining unit, 40 terminal information retaining unit

### BEST MODE FOR CARRYING OUT THE INVENTION

### First Embodiment

According to this embodiment, there are proposed novel types of advertisement display scenes in such a manner that an advertisement is displayed on the desktop wallpaper of a personal computer, or an advertisement relating to an operating state of various types of applications is displayed in a window thereof. In addition, there is also proposed a new business model, by which a user selects an advertisement to be displayed in accordance with a different scene, the advertisement is displayed, and then the user receives payment from a sponsor thereof.

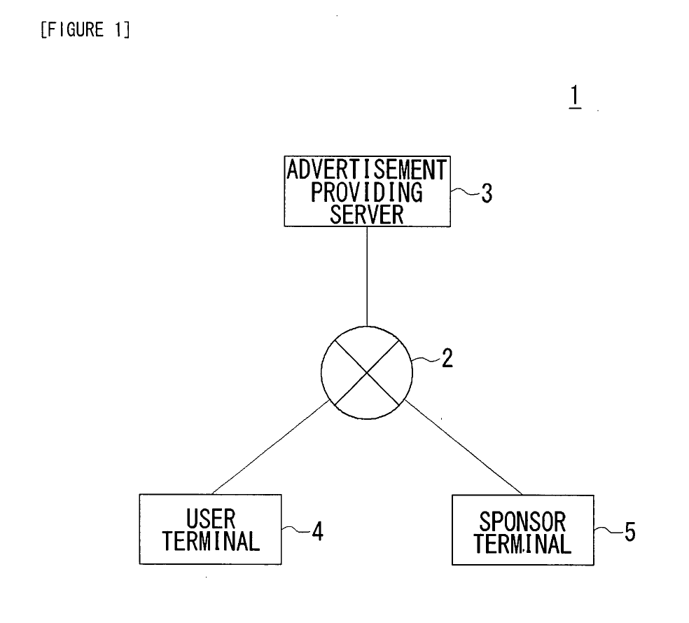

FIG. 1 illustrates a configuration of an advertisement delivery system 1 according to an embodiment of the present invention.

The advertisement delivery system 1 includes: an advertisement providing server 3; a user terminal 4; and a sponsor terminal 5. These are connected with each other via the Internet 2. The sponsor terminal 5 transmits an advertisement thereof to the advertisement providing server 3, and makes a request for a delivery of the advertisement. The advertisement providing server 3 offers an opportunity whereby a user sells an advertisement display scene thereof to an advertiser, that is to say, the advertisement providing server 3 offers an opportunity whereby a user solicits sponsorship for the user's display region. In this advertisement selling site, a user may look for a sponsor by setting a selling price in accordance with a size of the display region for advertisement or a display scene. Conversely, an advertisement provider may set a price for an advertisement so that a user may select an advertisement to be displayed in accordance with the size of the display region for advertisement or in accordance with the display scene after looking at the price. When an agreement is reached between the user and the sponsor, the advertisement providing server 3 delivers the advertisement to the user terminal 4 through the Internet 2. The advertisement providing server 3 may run an advertisement selling site only, and if an agreement is reached, an advertisement may be delivered directly from the sponsor terminal 5 to the user terminal 4.

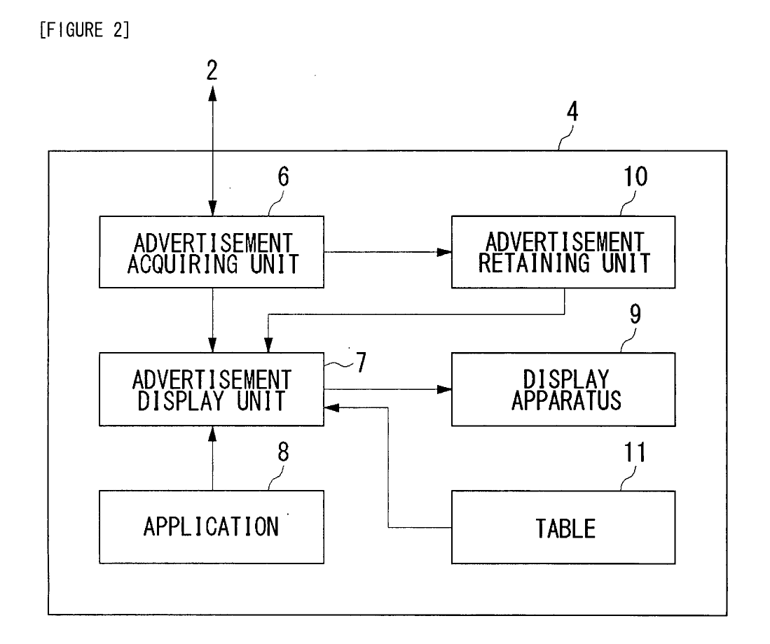

FIG. 2 illustrates a configuration of the user terminal 4.

The user terminal 4 serves as an advertisement managing apparatus and includes: an advertisement acquiring unit 6; an advertisement display unit 7; an advertisement retaining unit 10; a table 11; an application 8; and a display apparatus 9. The advertisement acquiring unit 6 acquires an advertisement from the advertisement providing server 3 via the Internet 2. The advertisement retaining unit 10 retains such acquired advertisement. The table 11 stores an advertisement display scene provided from the application in association with the type of advertisement to be displayed in the scene. Upon being notified that it is time to display an advertisement from the application 8, the advertisement display unit 7 refers to the table 11, acquires the type of advertisement to be displayed, reads the advertisement out of the advertisement retaining unit 10, and displays the same on the display apparatus 9.

The application 8 communicates the time to display the advertisement based upon a given condition. For example, while an input from a user is being received by a Japanese conversion application and when the received word matches a predetermined keyword, an advertisement relating to the keyword may be displayed. Alternatively, Operating System (OS) may communicate the time to display the advertisement on the desktop wallpaper at startup, so that the advertisement may be displayed continuously on the desktop from then on. Since the desktop wallpaper is always being displayed while a personal computer is running, the highest price may be set. In addition thereto, an advertisement may be displayed on the startup screen of a personal computer, or may be displayed while a user waits for a printing job to complete.

The advertisement price may be charged according to the number of display times or the display period. In each case, the advertisement display unit 7 may manage the number of display times of an advertisement or the display period thereof, notify the advertisement providing server 3 or the sponsor terminal 5 according to a given time schedule, and then charge the price.

When the displayed time is notified from the application 8, the advertisement display unit 7 may acquire and display the advertisement. In this case, the advertisement retaining unit 10 may not be provided.

The above technique is applicable not only to personal computers but also to apparatuses in general communicable via a network and having a display screen such as mobile phones, car navigation systems, and the like.

According to the technique used in the present embodiment, it is possible to provide a technique for delivering an advertisement that interests a user and to cause the user himself/herself to select an advertisement to be displayed, whereby the user's resistance to the advertisement can be lowered and the advertisement can be delivered in a more effective manner.

With respect to the foregoing, some remarks will be added.

In another embodiment described below, the advertisement providing server 3 acquires and retains advertisement data from the sponsor terminal 5. Upon receiving the delivery of the advertisement data from the advertisement providing server 3, the user terminal 4 retains the advertisement. A user is able to set freely in the user terminal 4, an advertisement display condition such as the displayed time and the period of the advertisement data, the size of the advertisement display region, or the like. The advertisement display condition may be predetermined in an advertisement display contract between the user and the advertiser. The advertisement providing server 3 selects the advertisement data and sends the data to the user terminal 4. The user terminal 4 displays the latest advertisement data provided according to the advertisement display condition. That is to say, in a model described below, the advertisement data to be displayed on the user terminal 4 is selected by the advertisement providing server 3, instead of the user terminal 4. Alternatively, the user terminal 4 may be an apparatus dedicated to advertisement display. In this case, the advertisement is always being displayed.

An advertiser gives at least one point that is convertible into cash (hereinafter, referred to as “advertisement point”) to a user of the user terminal 4 that has displayed the advertisement data of the advertiser. The advertisement point is calculated in accordance with not only the actual display result of the advertisement data but also the value as an advertising medium for every user terminal 4. The user obtains the right of demanding cash from the advertiser, on the basis of the given advertisement point. The advertisement point may be paid directly from the advertiser to the user terminal 4 in the form of electronic money.

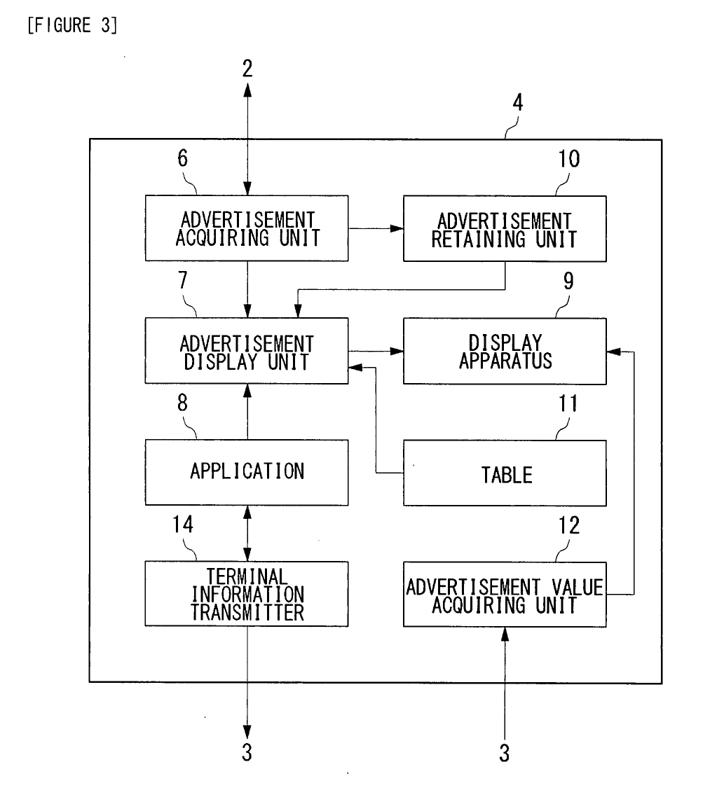

FIG. 3 is a functional block diagram showing another configuration of the user terminal shown in FIG. 2.

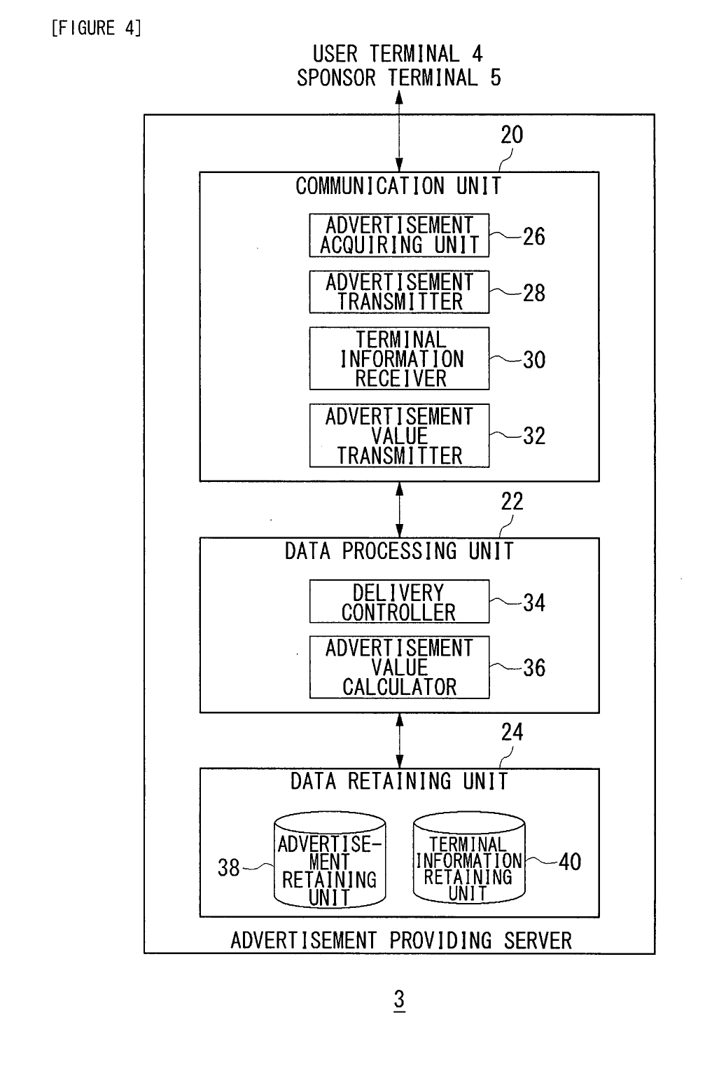

Each block shown therein can be achieved with a device or mechanical device as typified by a CPU of a computer in terms of hardware, and be achieved with a computer program or the like in terms of software. However, there are shown functional blocks realized through cooperation therebetween. Therefore, as will be understood by those skilled, the functional blocks can be achieved in different forms in accordance with the combination of hardware and software. This is similar to a functional block diagram of the advertisement providing server 3 shown in FIG. 4. The user terminal 4 may be a personal computer with a monitor, or may be an information processing apparatus equipped with a display function and a communication function, such as a mobile phone or car navigation system. As a matter of course, the user terminal 4 may be configured as an apparatus dedicated to advertisement display.

The user terminal 4 shown in the figure includes a terminal information transmitter 14 and an advertisement value acquiring unit 12, in addition to the configuration of the user terminal 4 shown in FIG. 2.

The terminal information transmitter 14 sends terminal information to the advertisement providing server 3. The terminal information, described herein, refers to original data for calculating an advertising medium value of the user terminal 4, and serves as a profile relating to the advertising medium value of the user terminal 4. The “advertising medium value” means the advertisement point in a narrow sense, whereas “advertising medium value” means a value as an advertising medium of the user terminal 4 in a broad sense. The value as the advertising medium is varied depending on the type of the user terminal 4, the user, the usage state, the advertisement display condition, and a commercial product or service to be publicized or advertised (hereinafter, referred to as “advertised object”). Items of information included as the terminal information are broadly categorized into four as described below.

That is to say, there are four types:
1. apparatus information: information on the type of the user terminal 4
2. user information: information on the user of the user terminal 4
3. usage information: information on the usage state of the user terminal 4
4. actual result information: information on the actual display result in the user terminal 4

Since the apparatus information and the user information out of the terminal information are not often changed over time, the apparatus information and the user information may be registered in the advertisement providing server 3 at the time of finalizing the advertisement display contract.

The application 8 of the user terminal 4 maintains the record of the usage state of the user terminal 4 and the display state of an advertisement, as the usage information and the actual result information, respectively. The terminal information transmitter 14 sends to the advertisement providing server 3, the terminal information including the usage information and the actual result information that have been maintained. Firstly, the advertisement providing server 3 quantifies the value as an advertising medium of each user terminal 4, as a fundamental evaluation value.

In the present embodiment, the fundamental evaluation value is calculated based upon the apparatus information, the user information, and the usage information in the terminal information. The advertisement point is calculated by adding the actual result information representing the actual display result of the advertisement to the fundamental evaluation value. The advertisement value acquiring unit 12 receives evaluation information representing the fundamental evaluation value of the user terminal 4 and the advertisement point obtained.

The advertisement point is calculated, for example, on a monthly basis, and is sent to the user terminal 4 from the advertisement providing server 3. The advertisement value acquiring unit 12 causes the display apparatus 9 to display the fundamental evaluation value and the advertisement point.

FIG. 4 is a functional block diagram of an advertisement providing server that delivers advertisement data to the user terminal of FIG. 3.

The advertisement providing server 3 includes a communication unit 20, a data processing unit 22, and a data retaining unit 24.

The communication unit 20 is in charge of communication processing with the user terminal 4 and the sponsor terminal 5. The data processing unit 22 performs various types of data processing based upon the data acquired from the communication unit 20. The data processing unit 22 also serves as an interface between the communication unit 20 and the data retaining unit 24. The data retaining unit 24 stores various types of data including prepared various types of setting data and the data received from the data processing unit 22.

The communication unit 20 includes an advertisement acquiring unit 26, an advertisement transmitter 28, a terminal information receiver 30, and an advertisement value transmitter 32.

The advertisement acquiring unit 26 receives the advertisement data from the sponsor terminal 5. The advertisement transmitter 28 sends the advertisement data to each user terminal 4. The terminal information receiver 30 receives the terminal information from each user terminal 4. The advertisement value transmitter 32 sends the advertisement point and the evaluation information showing the fundamental evaluation value.

The data processing unit 22 includes a delivery controller 34 and an advertisement value calculator 36.

The delivery controller 34 selects the advertisement data to be sent to the user terminal 4 according to the terminal information, and also controls the timing of delivery of the advertisement data. The advertisement value calculator 36 calculates the fundamental evaluation value and the advertisement point on the basis of the terminal information. The advertisement point is converted into cash value by a given conversion function. As an example, one advertisement point may be converted into one dollar.

Advertisement objects are categorized by a given evaluation standard. The advertisement value calculator 36 calculates the fundamental evaluation value for every category. For example, the advertised objects are categorized into “commodity”, “food”, “restaurant”, “computer game”, and the like.

If the user terminal 4 is used by a homemaker, a high advertising effect can be expected from advertised objects relating to commodities or foods. In other words, it can be said that such user terminal is high in the advertising medium value with respect to the commodities and foods. Meanwhile, if the user terminal 4 is a car navigation system, it can be considered that high advertisement effects are expected about automobile related products. In delivering the advertisement data to a user terminal 4, the delivery controller 34 selects the advertisement data corresponding to the category of high fundamental evaluation value, as an object to be sent. In this manner, the advertisement data expected to produce high effects can be selectively delivered by calculating the fundamental evaluation value in accordance with the advertised object.

The data retaining unit 24 includes an advertisement retaining unit 38 and a terminal information retaining unit 40.

The advertisement retaining unit 38 retains the advertisement data acquired from the sponsor terminal 5. The terminal information retaining unit 40 retains the terminal information acquired from the user terminal 4. In addition thereto, the data retaining unit 24 stores various types of information such as the fundamental evaluation value for each user terminal 4, the advertisement point, and the like.

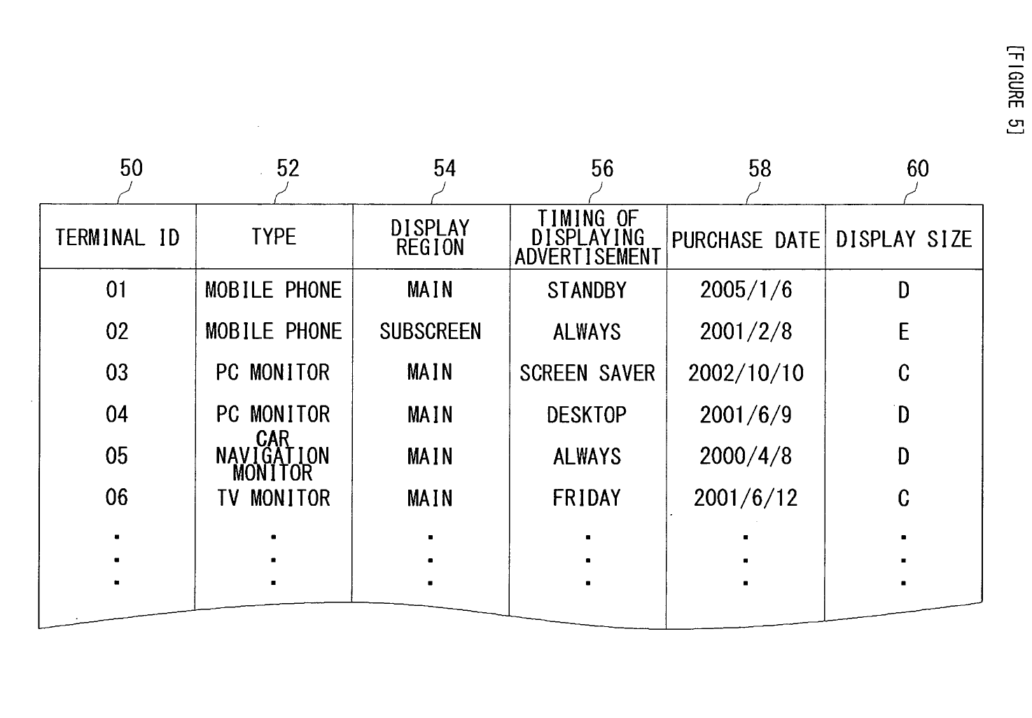

FIG. 5 illustrates a data structure of apparatus information in terminal information.

The apparatus information is stored in the terminal information retaining unit 40 as a portion of the terminal information. A terminal ID column 50 represents the terminal ID applied to identify the user terminal 4. An apparatus type column 52 represents the type of apparatus of a user terminal 4. The table shows that a user terminal 4 having a terminal ID “01” is a mobile phone, and a user terminal 4 having a terminal ID “03” is a monitor of a personal computer. The type of apparatus may be further classified according to the model number.

A display region column 54 represents the advertisement display region of the user terminal 4. The user terminal 4 having the terminal ID of “01” and that having the terminal ID of “02” are both mobile phones. However, an advertisement is displayed on the main screen of the user terminal 4 having the terminal ID of “01”, whereas an advertisement is displayed on a subscreen of a double-screened mobile phone of the user terminal 4 having the terminal ID of “02”.

An advertisement display timing column 56 represents the time when an advertisement is displayed on the user terminal 4. In the user terminal 4 having the terminal ID of “01”, the advertisement is displayed on a standby screen of the mobile phone. In the user terminal 4 having the terminal ID of “03”, the advertisement is displayed at the time of activation of a screen saver. In addition, in the user terminal 4 having the terminal ID of “06”, the advertisement is displayed only on Fridays.

A purchase date column 58 represents a date when the user terminal 4 was purchased. It is easy to assume that the user terminal 4 recently purchased possibly attracts attention from others. For example, a new type of mobile phone attracts a lot of attraction, and accordingly, the advertising medium value thereof may be possibly high. On the other hand, an advertisement of a new mobile phone may be effective if the user terminal 4 is an old type of mobile phone.

The user terminal 4 may be an apparatus dedicated for advertisement display. Also in a case where the user terminal 4 is an apparatus dedicated for advertisement display, the advertisement display timing column 56 shows “always”. Also, the display region column 54 shows “full-screen display”.

In a display size column 60, the display size of the advertisement display region is ranked into five levels of A to E. A indicates the largest and E indicates the smallest. An advertisement is not necessarily displayed in the whole screen, and may be partially displayed therein. Also, the advertisement is not necessarily displayed on the screen all the time, and may be displayed only for a given period of time.

In the present embodiment, each item of the apparatus information shown in the figure is scored, and the total thereof represents a value as an advertising medium based upon the apparatus information (hereinafter, referred to as “first evaluation value”). The first evaluation value is calculated according to the category of the advertised object. Here, the calculation method is not limited thereto, and may be arbitrarily set at the advertisement providing server 3. The items included in the apparatus information are not limited to those shown in the figure.

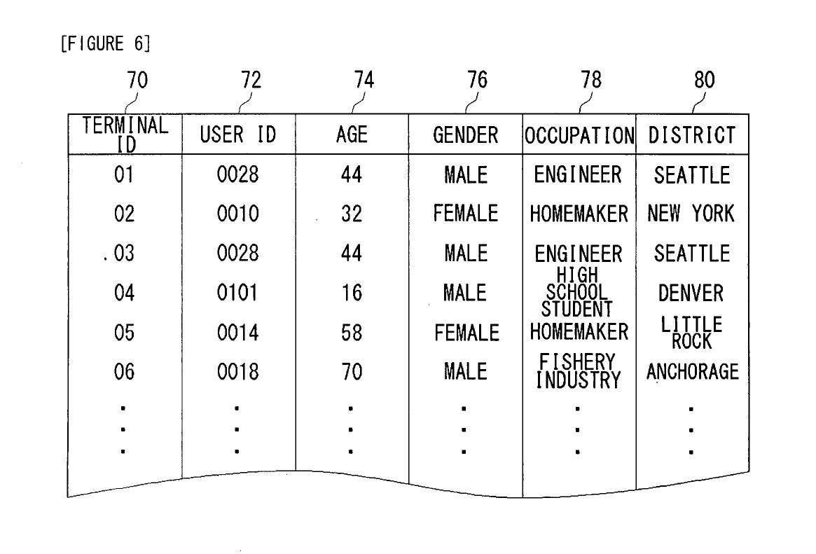

FIG. 6 illustrates a data structure of user information in the terminal information.

The user information is also stored in the terminal information retaining unit 40, as a portion of the terminal information. The terminal ID column 70 presents a terminal ID. A user ID column 72 presents a user ID for identifying a user. An age column 74 presents a user's age. A gender column 76 presents a user's gender. An occupation column 78 presents a user's occupation. In addition, a district column 80 presents a user's living area.

Depending on the target user, the advertising medium value varies. The advertising medium value depends on, for example, whether the user belongs to wealthy class, whether the user belongs to an age group including avid consumers, or whether the user lives in an urban area. Also, the advertised object having a high advertising effect varies depending on the user. The district column 80 may present information on whether or not the living area is busy with people. For example, if a person who lives in an apartment building facing a busy street with people and cars displays an advertisement to the busy street, the advertising medium value is especially high.

In the present embodiment, each item of the user information shown in the figure is scored, and the total thereof represents a value as an advertising medium based upon the user information (hereinafter, referred to as “second evaluation value”). The second evaluation value is also calculated according to the category of the advertised object.

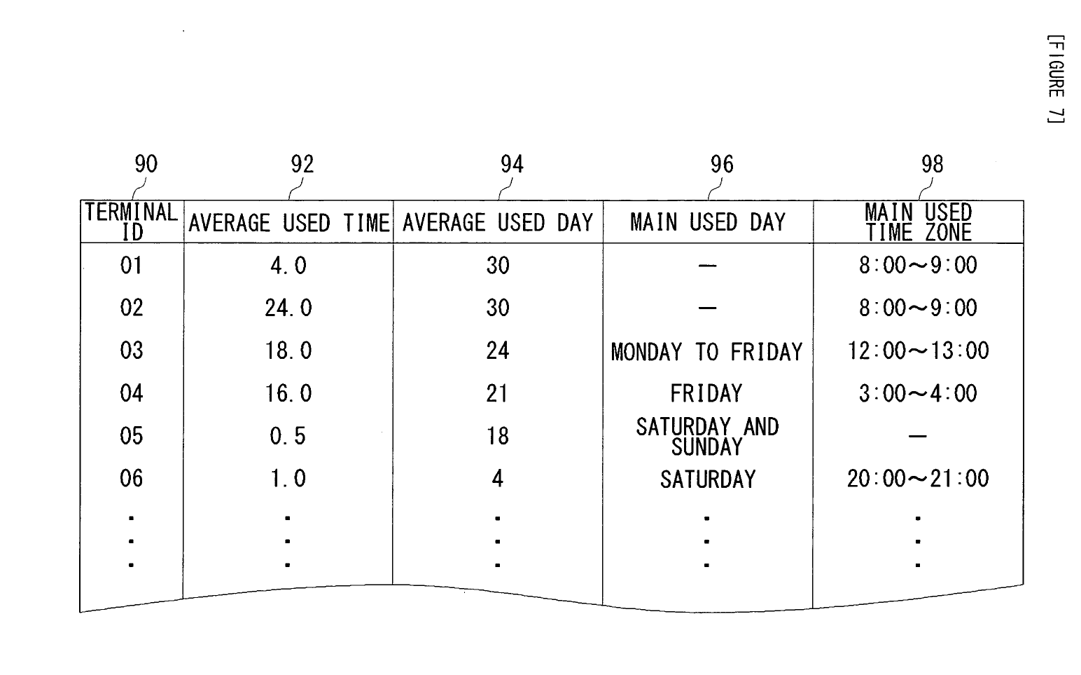

FIG. 7 illustrates a data structure of usage information in the terminal information.

The usage information is also stored in the terminal information retaining unit 40, as a portion of the terminal information. The usage information represents data that changes over time during a counting period of the past thirty days. A terminal ID column 90 represents a terminal ID. An average used time column 92 represents an average used time of each user terminal 4 in one day. The used time means that, for example, a period while a power thereof is kept on and the display function thereof is being activated, in a day. An average used day column 94 represents an average number of days the user terminal 4 is used. For example, if at least 0.5 hour is used in a day, such day is counted as a used day.

A main used day column 96 represents a day of week on which the user terminal 4 is especially used (hereinafter, referred to as “main used day”). For example, if the used period is greater than the average used time by at least ten percent, such day is counted as a main used day. With respect to the user terminal 4 having the terminal ID of “03”, from Monday to Friday, namely, weekdays are mainly used. Meanwhile, the user terminal 4 having the terminal ID of “01” is steadily used regardless of the day of the week.

A main used time zone column 98 represents a time zone when the user terminal 4 is especially used (hereinafter, referred to as “main used time zone”). The main used time zone means a time zone while the user terminal 4 is being used most, determined according to twenty-four time zones of a day.

Depending on the usage state of the user terminal 4, the advertising medium value of the user terminal 4 differs. If the user terminal 4 is not used very frequently, the advertising medium value will be small. Also, depending on the usage information, the advertised object of high advertising effects differs. For example, in a personal computer to be used in an office, an advertisement on a nearby restaurant is highly effective, if it is before dinner.

In the present embodiment, each item of the usage information shown in the figure is scored, and the total thereof represents a value as an advertising medium based on the usage information (hereinafter, referred to as “third evaluation value”). The third evaluation value is also calculated according to the category of the advertised object.

In this manner, the first through third evaluation values are respectively calculated in accordance with the apparatus information, the user information, and the usage information. The advertisement value calculator 36 performs a weighted average of the three types of the evaluation values so as to calculate the fundamental evaluation value indicating the overall advertising medium value of the user terminal 4. For example, if a commodity is set as an advertised object in a user terminal 4 and the first, second, and third evaluation values are respectively 90, 80, and 85, the advertisement value calculator 36 may determine the average value thereof of 85 as the fundamental evaluation value of the commodity. In sending various types of advertisement data to different user terminals 4, the delivery controller 34 sends the advertisement data corresponding to the category having a high fundamental evaluation value. This allows the advertisement data to be provided in an efficient manner according to the user terminal 4. As a matter of course, a user of the user terminal 4 may voluntarily make a request to the advertisement providing server 3 for an advertisement on the information that the user wants to know, and such user's interest may be reflected on the fundamental evaluation value.

In performing the weighted average of the three evaluation values, the advertisement value calculator 36 may change the weighting according to the advertised object. For example, since a car navigation system is a user terminal 4 to be personally used, it is likely that the user information counts heavily in determining the advertising effect. Meanwhile, since a personal computer to be used in an office functions as an advertising medium exposed to lots of people, it is likely that the relation between the user information and the advertising effect is not so close.

The application 8 of the user terminal 4 sends the actual result information indicating an actual display result of an actual advertisement, to the advertisement providing server 3. The actual display result may represent a displayed period of every advertisement that has been displayed in the past thirty days. The advertisement value calculator 36 of the advertisement providing server 3 calculates the advertisement point based on the fundamental evaluation value and the actual result information. As an example, it is assumed that 70 is the fundamental evaluation value of a product relating to a car, and it is also assumed that four hours is a period of displaying an advertisement on a brand-new car in the past thirty days. In this case, the advertisement point may be calculated as 280 points, for example, since 70×4=280. This calculation method is an example. A rational advertisement cost from a viewpoint of an advertiser can be calculated by calculating the advertisement point based on the fundamental evaluation value and the actual result information, in accordance with the category of the advertised object. In addition, from a viewpoint of a user, the advertising medium value of the user terminal 4 can be increased according to various elements and the actual display result, which have been described with reference to FIG. 5 through FIG. 7.

Also, if the advertisement display results in an actual purchasing activity, the advertising medium value of the user terminal 4 may be set much higher.

Furthermore, not only the actual display result of the advertisement but also the advertising effect may be reflected on the advertising medium value. For example, if a product is purchased by use of the user terminal 4, the advertising medium value of the user terminal 4 may be set higher. The terminal ID identifying the user terminal 4 may be applied to the advertisement displayed in the user terminal 4. Then, in purchasing a product after watching the advertisement thereof, a purchaser is able to receive a benefit such as a discount or the like, by letting know the terminal ID at a shop. Meanwhile, the shop sends the terminal ID to the advertisement providing server 3. The advertisement providing server 3 is capable of figuring out which advertisement in which user terminal 4 results in the actual result of purchase, by receiving the terminal ID. Alternatively, a user may be able to place an order for a product via the user terminal 4. At this time, the terminal ID is sent to the advertisement providing server 3 from the user terminal 4. The advertisement providing server 3 adjusts the advertising medium value of the user terminal 4 according to the number of receipt of the terminal ID and the advertised object. The advertisement providing server 3 may be equipped with a communication unit for acquiring the terminal ID at the time of purchase. Alternatively, the terminal information transmitter 14 may also have such functionality.

In addition, the user terminal 4 may be equipped with a camera so as to record an image of one or more viewers present in front of the advertisement being displayed and so as to measure the number thereof and the time of each viewer being spent in front of the camera. Then, as a portion of the terminal information, the user terminal 4 may send the information on the number of viewers measured, to the advertisement providing server 3. By receiving such information, the advertisement providing server 3 is capable of figuring out to what extent the advertisement displayed in the user terminal 4 influences the viewer. The advertisement providing server 3 adjusts the advertising medium value of the user terminal 4 in accordance with the terminal information relating to the viewer.

According to the embodiment described heretofore, it is possible to reduce the introduction cost by concluding an advertisement display contract, when computers are introduced all together in a company. Also, it is possible to construct a system encouraging each user to act for improving the advertising medium value of his/her terminal voluntarily.

An advertiser can advertise more effectively since the embodiment provides more efficient, user-targeted advertisement than commercial films or banner advertisement. Also, the advertising medium value for each user terminal 4 can be quantified according to the advertised object, thereby making it easy to determine a rational advertising cost.

Meanwhile, a user is able to make a profit by offering a spare time or vacant display area of the user terminal 4, respectively. In particular, the desktop screen or screen saver has a high advertising medium value, because of a large display area and a long display period thereof, so it is greatly beneficial for the user to set the desktop screen or screen saver as a means of an advertisement display contract.

Users tend to show a product to others willingly, just after purchasing the product such as a mobile phone or car. Also, such product attracts others' attention. In other words, just after the purchase, it is believed that the advertising medium value is high. In accordance with the user terminal 4 described in the present embodiment, since the date of purchase is a portion of the terminal information, it is possible to determine the advertising medium value in consideration of such human psychology. Furthermore, by use of the date of purchase, an advertisement to be provided may be selected. In a case of a car navigation system installed in a brand-new car, a passenger of the car may be a target of the advertisement of the car itself with an advertisement saying, “there is a convenient storage space under the front-passenger's seat”. Alternatively, the driver may be a target of an optional product of the car. What is more, information saying, “when you push this button of the car navigation, you will be connected to an on-line movie store” may be advertised. The above advertisements effectively increase feelings of satisfaction of the ownership, thereby also effectively maintaining the customer's loyalty to product, enterprise, and brand.

Furthermore, if the user terminal 4 is a large-scale display apparatus like an electric bulletin board, a user thereof can expect a greater profit by setting the user terminal 4 at a place where others are easily recognize. For example, a high advertising medium value is readily applied to a user living in a busy area like near a station or in a high-rise apartment building. Even in a bed-sitting room facing the north, for example, a high advertising medium value can be expected, if the room faces a busy street with a lot of traffic. Such an apartment building has a low value as a living environment, but has a high advertising medium value. Therefore, if the user sets a PC with a large-sized liquid crystal by the window or an electric bulletin board dedicated for advertisement display to display an advertisement for twenty-four hours, the user will be able to get a high profit. Consequently, in accordance with the advertisement delivery system 1, latent advertising medium value depending on the habitat is easily transferred to an earnings model. A high level of the advertising medium value has the possibility of increasing real-estate values. In general, although the asset value of real estate is determined in consideration with convenience, comfort, and the like, the advertisement delivery system 1 is capable of providing the real estate with a new asset quality, whereby there are great ripple effects on economy.

In addition, it is considered advantageous to install a liquid crystal at a rear seat of an owner-driver taxi, or a notebook PC is located at a waiting room of a beauty salon or hospital. An automatic dispenser may be equipped with a function of the user terminal 4 described in the present embodiment. Conventionally, it has been difficult to set such a small space as an advertising medium due to an advertising agency cost. However, according to a method proposed by the present invention, gathering display spaces owned by countless number of people enables the advertising effects to be enhanced as a whole. As described, according to an aspect of the present invention, it is effective in creating a new marketing method, value, or market, by which a general user becomes a business owner who provides an advertising medium.

The description of the present invention given above is based upon the embodiments. The embodiments are illustrative in nature and various variations in constituting elements and processes involved are possible. Those skilled in the art would readily appreciate that such variations are also within the scope of the present invention.

The function of an advertisement delivery apparatus described in the scope of claims is accomplished by the advertisement providing server 3 used in the embodiment, and the function of an advertisement display apparatus is accomplished by the user terminal 4. The function of a profile information receiver described in the scope of claims is accomplished by the terminal information receiver 30 used in the embodiment. The function of a profile information transmitter described in the scope of claims is accomplished by the terminal information transmitter 14 used in the embodiment. The function of an advertisement value notifying unit described in the scope of claims is accomplished by the cooperation of the advertisement value acquiring unit 12 and the display apparatus 9 used in the embodiment. In addition, profile information described in the scope of claims is mainly described as the terminal information used in the embodiment.

It also should be understood by those skilled in the art that each function fulfilled by each of the components described in the scope of claims is accomplished by a single unit of each functional block shown in the embodiment or by cooperation of units thereof.

### INDUSTRIAL APPLICABILITY

According to an aspect of the present invention, it is possible to provide a highly effective and novel advertisement delivery technique.

1. An advertisement management apparatus comprising:
means for acquiring an advertisement via a network;
a table which retains a scene for displaying the advertisement in association with a type of the advertisement to be displayed in the scene;
means for acquiring a notification of timing of display of the advertisement from an application; and
means for displaying the advertisement associated with the scene at the time of receiving the notification.

2. An advertisement delivery apparatus connected via a communication network with a terminal apparatus used by a user who has agreed to an advertisement display contract, comprising:
an advertisement data retaining unit which retains advertisement data for delivery;
an advertisement data transmitter which transmits advertisement data to be displayed to a terminal apparatus so as to display the advertisement data on a screen of the terminal apparatus
a profile information receiver which receives from the terminal apparatus, profile information relating to the terminal apparatus; and
an advertisement value determining unit which determines an advertising medium value of the terminal apparatus in accordance with the profile information.

3. The advertisement delivery apparatus according to claim 2, wherein the profile information receiver receives an actual display result of the advertisement data, as the profile information.

4. The advertisement delivery apparatus according to claim 2, wherein the profile information receiver receives information indicating a date when the terminal apparatus was purchased by a user, as the profile information.

5. The advertisement delivery apparatus according to claim 2, wherein the profile information receiver receives information indicating an installed location of the terminal apparatus, as the profile information.

6. The advertisement delivery apparatus according to claim 2, wherein the profile information receiver receives information relating to a viewer of an advertisement displayed on the terminal apparatus, as the profile information.

7. The advertisement delivery apparatus according to claim 2, further comprising an actual purchase result information acquiring unit which acquires actual purchase result information for identifying the terminal apparatus that has displayed the advertisement leading up to an actual purchase,
wherein the advertisement value determining unit adjusts the advertising medium value of the terminal apparatus in accordance with the actual purchase result.

8. The advertisement delivery apparatus according to claim 2, further comprising a user information retaining unit which retains user information relating to a user of the terminal apparatus,
wherein the advertisement data transmitter selects the advertisement data to be transmitted to the terminal apparatus in accordance with the user information.

9. The advertisement delivery apparatus according to claim 2, wherein the advertisement value determining unit calculates the advertising medium value of the terminal apparatus in accordance with an advertised object.

10. The advertisement delivery apparatus according to claim 2, wherein the advertisement data transmitter selects the advertisement data to be sent in accordance with the type of the terminal apparatus.

11. The advertisement delivery apparatus according to claim 2, wherein the advertisement value determining unit calculates the advertising medium value in accordance with the type of the terminal apparatus.

12. The advertisement delivery apparatus according to claim 2, wherein the advertisement value determining unit calculates the advertising medium value in accordance with an advertisement display condition set in the terminal apparatus.

13. An advertisement display apparatus connected via a communication network with a server apparatus equipped with a function of delivering advertisement data, comprising:
an advertisement acquiring unit which receives advertisement data from the server apparatus;
an advertisement retaining unit which retains the advertisement data;
a screen display unit which displays the advertisement data on a screen;
a profile information transmitter which transmits profile information on the advertisement display apparatus to the server apparatus;
an advertisement value acquiring unit which receives advertisement value information indicating an advertising medium value of the advertisement display apparatus in accordance with the profile information; and
an advertisement value notifying unit which communicates the advertising medium value of the advertisement display apparatus to a user.

14. The advertisement display apparatus according to claim 13, wherein the profile information transmitter transmits information indicating an actual display result of the advertisement data, as the profile information.

15. The advertisement display apparatus according to claim 13, which serves as an apparatus dedicated for advertisement display, wherein the screen display unit causes an application dedicated for advertisement display to display the advertisement data on a screen.

16. The advertisement display apparatus according to claim 13, wherein the screen display unit displays the advertisement data when a predetermined advertisement display condition is satisfied, and displays image data other than the advertisement data when the advertisement display condition is not satisfied.

17. The advertisement display apparatus according to claim 16, wherein the screen display unit displays the advertisement data on a desktop screen of a personal computer.

18. The advertisement display apparatus according to claim 16, wherein the screen display unit displays the advertisement data as a screen saver.

19. An advertisement delivery method performed by an apparatus connected via a communication network with a terminal apparatus used by a user who has concluded an advertisement display contract, the advertisement delivery method comprising:
transmitting advertisement data to be displayed to a terminal apparatus so as to display the advertisement data on a screen of the terminal apparatus;
receiving from the terminal apparatus, profile information on the terminal apparatus; and
calculating an advertising medium value of the terminal apparatus in accordance with the profile information.

20. An advertisement display method performed by a terminal apparatus connected via a communication network with a server apparatus equipped with a function of delivering advertisement data, comprising:
receiving the advertisement data from the server apparatus;
displaying the advertisement data on a screen;
transmitting profile information on the terminal apparatus to the server apparatus;
receiving advertising value information indicating an advertising medium value of the terminal apparatus in accordance with the profile information, from the server apparatus; and
communicating the advertising medium value of the terminal apparatus to a user.

21. A computer program product for an apparatus connected via a communication network with a terminal apparatus used by a user who has concluded an advertisement display contract, comprising the modules for:
retaining advertisement data for delivery;
transmitting advertisement data to be displayed to a terminal apparatus to display the advertisement data on a screen of the terminal apparatus;
receiving from the terminal apparatus, profile information on the terminal apparatus; and
calculating an advertising medium value of the terminal apparatus in accordance with the profile information.

22. An advertisement display program product for a terminal apparatus connected via a communication network with a server apparatus equipped with a function of delivering advertisement data, comprising the modules for:
receiving the advertisement data from the server apparatus;
retaining the advertisement data;
displaying the advertisement data on a screen;
transmitting profile information on the terminal apparatus to the server apparatus;
receiving from the server apparatus, advertising value information indicating an advertising medium value of the terminal apparatus in accordance with the profile information; and
communicating the advertising medium value of the terminal apparatus to a user.
